(19) United States
(12) Patent Application Publication
(10) Pub. No.: US 2013/0242097 A1
(43) Pub. Date: Sep. 19, 2013

(54) VIDEO-BASED DETERMINATION OF VEHICLE COMPONENT RISK FOR FAILURE DUE TO OVERHEATING

(71) Applicants: George Cunha CARDOSO, Webster, NY (US); Lalit Keshav MESTHA, Fairport, NY (US); Mark S. CANTELLI, Germantown, MD (US); Edgar A. BERNAL, Webster, NY (US)

(72) Inventors: George Cunha CARDOSO, Webster, NY (US); Lalit Keshav MESTHA, Fairport, NY (US); Mark S. CANTELLI, Germantown, MD (US); Edgar A. BERNAL, Webster, NY (US)

(73) Assignee: XEROX CORPORATION, Norwalk, CT (US)

(21) Appl. No.: 13/419,605

(22) Filed: Mar. 14, 2012

(51) Int. Cl. H04N 5/33; H04N 7/18

(52) U.S. Cl. 348/148; 348/E07.085; 348/E05.09

(57) ABSTRACT

What is disclosed is a system for non-contact, video-based determination of vehicle component failure due to overheating. In a manner more fully disclosed herein, at least one infrared camera is used to capture an infrared image of a component of a vehicle to be inspected for overheating. The images are processed to isolate that component. A temperature is estimated for the isolated component in the image using a camera calibration curve which relates pixel intensities to temperature. A temperature threshold for the isolated component is retrieved from a database based upon a classification of the vehicle. The estimated temperature is then compared to that component's temperature threshold. If the estimated temperature is above the retrieved threshold, a signal is initiated. The teachings hereof find their uses in a variety of remote and non-cooperative vehicle inspection modes in the field of transportation safety. Various embodiments are disclosed.

### TECHNICAL FIELD

The present invention is directed to systems which utilize an infrared camera to capture an image of a vehicle and then analyze that image to determine an estimated temperature of a component of that vehicle such as, for example, a brake caliper, in order to determine whether that component is at risk of failure due to overheating.

### BACKGROUND

A vehicle has many parts such as, for example, the exhaust pipe, or the brake pads, wheel bearings, and the like, which generate heat during normal use and operation. Such parts have an operating temperature range. When that part starts heating up beyond the operating temperature, the part is at risk of failing. For example, brakes heat up when slowing a car down because, when the driver presses down on the brake pedal, a brake pad is pressed against a metal disc or drum which slows the vehicle down by friction. Although a brake system is designed for heat dissipation, excessive heat in one or more brake components may cause the vehicle's braking system to fail. Often, the driver or operator of the vehicle is unaware that the vehicle's brake system is at risk for failure until it is too late. In an effort to try to limit accidents because of vehicle component failure, many trucks and vehicles are required to undergo safety inspections often performed by a State Police or the Department of Transportation (DoT). It can be difficult for inspectors to reliably detect whether a system component of a vehicle is at risk for failure. This can be due to a limited amount of time allocated for an inspection and/or limited resources available to the inspector to perform a thorough inspection of that vehicle.

Accordingly, what is needed in this art is a non-contact vehicle inspection system which uses an infrared camera to capture images of a vehicle and then analyzes those images to estimate a temperature of components of that vehicle to determine whether any of the components are at risk of failure due to overheating.

### INCORPORATED REFERENCES

The following U.S. patents, U.S. patent applications, and Publications are incorporated herein in their entirety by reference.
“Template Matching Techniques in Computer Vision: Theory and Practice”, Roberto Brunelli, Wiley 1^{st} Ed. (May 2009), ISBN-13: 978-0470517062.
“Shape Detection in Computer Vision Using the Hough Transform”, V. F. Leavers (Author), Springer-Verlag, (December 1992), ISBN-13: 978-0387197234.
“Object Recognition”, M. Bennamoun (Author), George Mamic (Author), Springer; 1st Edition, (February 2002), ISBN-13: 978-1852333980.

### BRIEF SUMMARY

What is disclosed is a non-contact, video-based system and method which uses infrared cameras to capture infrared images of a vehicle and then analyzes those images to obtain an estimated temperature for components of interest in order to determine whether any of the components are at risk for failure due to overheating. In a manner more fully disclosed herein, the present system and method involves the following. At least one infrared camera is used to capture an infrared image of a component of a vehicle to be inspected for overheating. The images are processed to isolate that component. A temperature is estimated for the isolated component in the image using a camera calibration curve which relates pixel intensity values to temperature. A temperature threshold for the isolated component based upon a classification of the vehicle is retrieved from a database. The estimated temperature is then compared to that component's temperature threshold, which is an upper bound of an operating temperature range of the component. If the estimated temperature is above the retrieved threshold, a signal is initiated. The teachings hereof find their uses in a variety of remote and non-cooperative vehicle inspection modes in the field of transportation safety.

### BRIEF DESCRIPTION OF THE DRAWINGS

The foregoing and other features and advantages of the subject matter disclosed herein will be made apparent from the following detailed description in conjunction with the accompanying drawings, in which:

FIG. 1 illustrates one example embodiment of a vehicle inspection structure in accordance with the present system and method;

FIG. 2 illustrates a top-side cutaway view of lane 106B of the structure of FIG. 1;

FIG. 3 shows one of the cameras of the imaging array of FIG. 2 capturing infrared images of a brake component of a vehicle;

FIG. 4 illustrates a networked computing system and a database containing records of temperature thresholds for vehicle components based upon vehicle classification;

FIG. 5 is a flow diagram illustrating one embodiment of the present method for determining vehicle system component failure due to overheating as shown and discussed with respect to FIGS. 1-3 and the networked system of FIG. 4;

FIG. 6 is a continuation of the flow diagram of FIG. 5 with flow processing continuing with respect to node A; and

FIG. 7 illustrates one example system for performing various aspects of the teachings hereof as discussed with respect to the flow diagrams of FIGS. 5 and 6.

### DETAILED DESCRIPTION

What is disclosed is a non-contact, video-based system and method which uses infrared cameras to capture infrared images of a vehicle and then analyzes those images to obtain an estimated temperature for components of interest in order to determine whether any of the components are at risk for failure due to overheating.

### NON-LIMITING DEFINITIONS

A “vehicle” refers to any vehicle, however propelled, containing at least one component that has the potential of failing due to overheating.

An “image of a vehicle” means still images or a video of a vehicle captured using an infrared camera. A single frame of a fully-populated infrared image consists of an array of pixels with each pixel having intensity values measured at desired wavelength bands of interest.

An “infrared camera” is an apparatus designed to capture infrared (IR) light reflected from a target object, separate it into its component wavelengths, and output an infrared image of the object. The IR camera can be a Mid Wave Infrared (MWIR) camera and/or a Long Wave Infrared (LWIR) camera. Thermal imaging cameras operating in the MWIR and the LWIR region are readily available in various streams of commerce. Xenics, for instance, offers cameras having various resolutions and differing frame rate options.

A “component of interest” means a component of a vehicle intended to be analyzed in accordance with the teachings hereof such that a determination can be made whether that component is at risk of failure due to overheating. Components can be, for example, components of: a brake system, an exhaust system, an engine, a transmission, an axel, a wheel bearing, a radiator, and the like.

An “electronic tag” is a small integrated circuit with specialized onboard components for communicating with a sensor device. The vehicle's electronic tag is affixed to the vehicle, typically the inside of the front windshield. In one embodiment, an electronic tag is a RFID tag, as are known in the arts, which modulates/demodulates a radio frequency (RF) signal. RFID tags are often used to automatically collect tolls from a pre-funded account associated with that tag. According to various embodiments hereof, the vehicle's electronic tag communicates information about the motor vehicle. The electronic tag may be updated with new or additional information from time to time. Such an update may occur manually or automatically. Information about the motor vehicle is intended to be broadly construed to include, for example, the vehicle's identification number, year/make/model, the registered owner's contact such as name, address, phone, and email, and the like, along with the date of the vehicle's last emissions test.

A “vehicle classification” is based upon the type of vehicle. Vehicles may be classified into relatively large grouping comprising, for example, a passenger car or van, light and heavy duty trucks, a bus, farm equipment, off-road vehicles such as ATVs and the like, race cars, motorcycles, tractor trailers, a train, and a plane. Vehicles classes may further include information about a specific make, model, year, manufacturer, and the like.

A “temperature threshold” refers to a temperature above which a component is determined to be overheating. At least one temperature threshold is associated with each component of each vehicle classification. Depending on the classification system employed, a particular component may have a plurality of temperature thresholds associated therewith. For instance, a first temperature threshold may indicate that the component is starting to overheat and a second temperature threshold may indicate that the component is at risk of failure due to overheating. Various actions may be associated with a temperature threshold such as, for example, recommendations as to which parts of that particular component need to be closely inspected, serviced, or replaced. Temperature thresholds are determined apriori using, for example, a Design of Experiments (DoE) of component temperatures in a temperature-controlled environment or obtained from a Department of Transportation (DoT) agency, an Underwriters Laboratory (UL), a manufacturer of the component, and the like.

“Isolating a component in the IR image” means processing the image using image processing algorithms that are well understood by those of ordinary skill to determine which pixels of the image are associated with that component. Image processing techniques include, for instance, a Hough transform on a binarized gradient field of the image, training-based object classification method, and/or a template matching and correlation method, as are well known to practitioners of the applied computing arts. A temperature of the isolated component is estimated by having calibrated the camera pixels to temperature.

A “vehicle inspection authority” is, for example, a Department of Transportation Safety, Federal Aviation Administration, Homeland Security, or law enforcement agency, tasked with inspecting vehicles.

### Example Vehicle Inspection Station

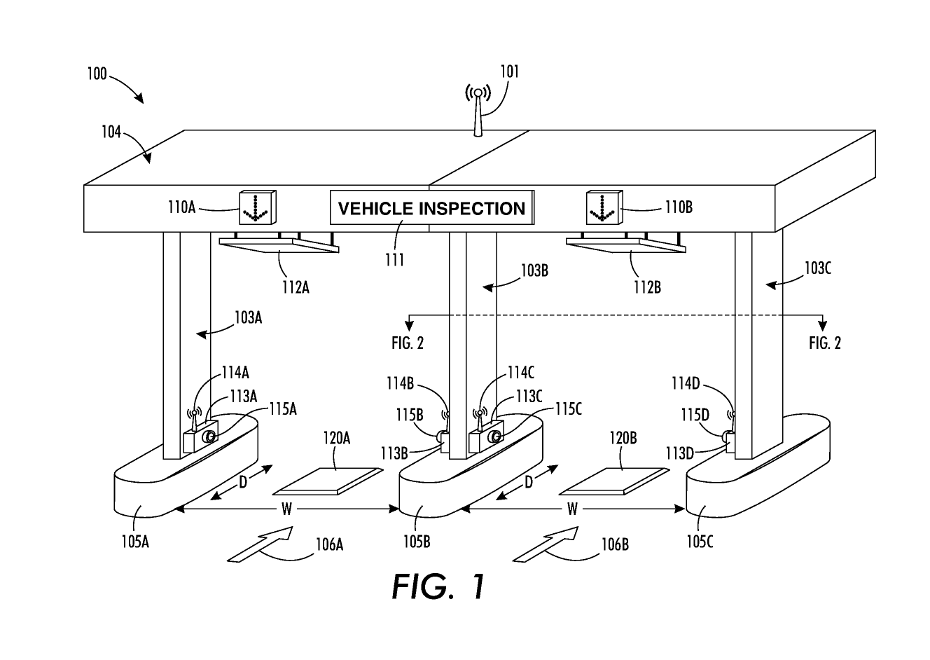

Reference is now being made to FIG. 1 which illustrates one example embodiment of a vehicle inspection station in accordance with one embodiment of the present system and method.

Inspection System 100 is shown comprising a structure having support walls 103A-C and a roof 104. Antenna 101 effectuates wireless communication with a workstation or other device over a network. Walls 103A-C are protected by support buttresses 105A-C, respectively. Walls 103A-C enclose two lanes 106A-B for vehicles to pass through in a direction shown by each lane's respective directional arrow. Illuminated signs 110A-B provide notification that the respective lane is open. Such signs are generally indicated with a green arrow when the lane is open and a red arrow when the lane is not open. Also positioned to the face of the structure is sign 111 which indicates that vehicle inspections are being performed. Electronic tag readers 112A-B are positioned above lanes 106A-B to query the vehicle's electronic tag. Each of the respective lanes has a set of cameras 113A-D for capturing images of the vehicle passing through that lane. Antennas 114A-D enable communication with a workstation (not shown). Positioned on the road surface in each of the lanes is an array of infrared imaging cameras 120A-B for capturing infrared images of components on the under-carriage of the vehicle as the vehicle passes overhead.

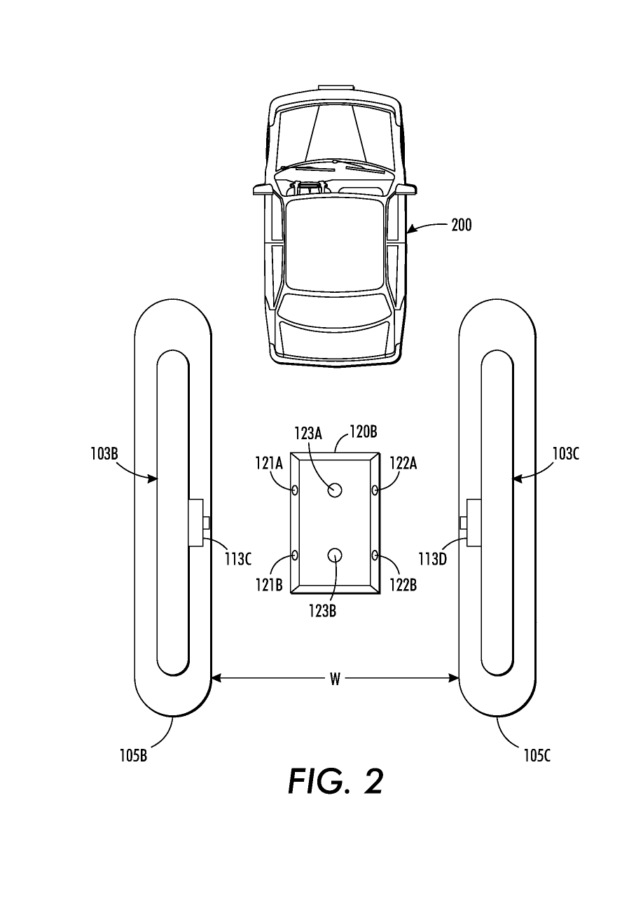

Reference is now being made to FIG. 2 which illustrates a top-side cutaway view of the lane 106B of the structure of FIG. 1.

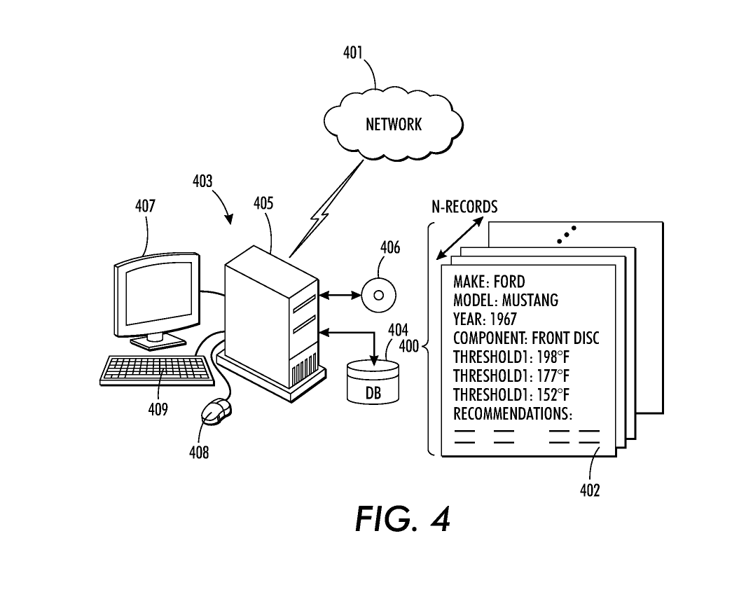

Vehicle 200 is shown having passed through lane 106B. Cameras 113C-D capture one or more images of the vehicle and communicates those images to a workstation such as the workstation of FIG. 4. These images may be processed to determine the vehicle's classification. In this embodiment, the electronic tag reader 112B has queried the vehicle's electronic tag on the vehicle's windshield to obtain the vehicle's classification, e.g., the make, model, and year. Infrared cameras are housed in array 120B that is on the surface of the road. Array 120B houses a plurality of infrared cameras shown with lens 121A-B and 122A-B positioned at an angle and lens 123A-B facing upward. Although shown as a plurality of cameras, housings 120A-B may contain a single infrared camera. Any of the infrared cameras are in communication with antenna 101 via wired or wireless connections, such that any of the captured IR images can be communicated to a workstation for image processing in accordance with the present method, and subsequent viewing.

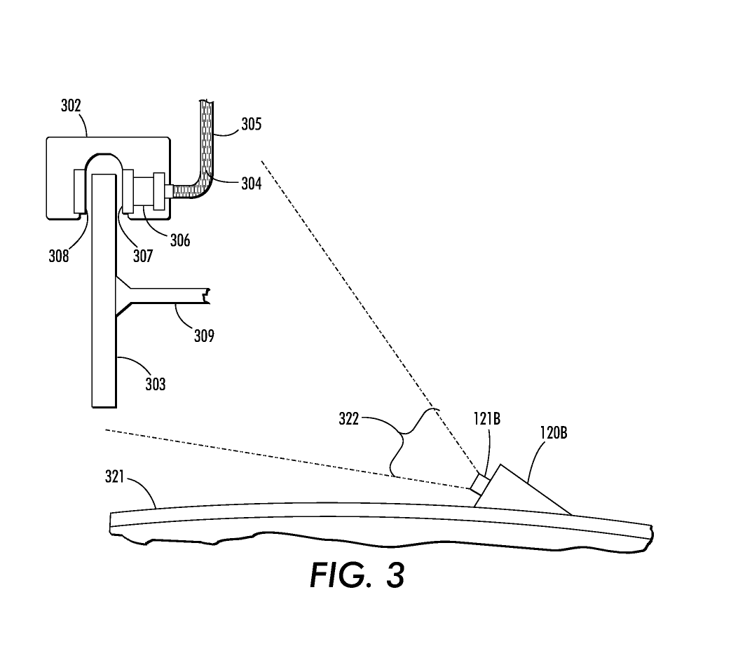

Reference is now being made to FIG. 3 which shows one of the cameras of the imaging array of FIG. 2 capturing infrared images of a brake component of a vehicle.

In FIG. 3, the system component 310 undergoing inspection comprises the brake caliper 302 and the disc 303. Brake fluid 304 is provided via brake line 305 to a piston 306 from a reservoir hydraulically connected to a master cylinder which compresses the brake fluid by the application of a plunger connected to a brake pedal or lever. Brake caliper 302 is affixed to a frame (not shown) such that a portion of disc 303 can rotatably pass therethrough. Piston 306 inside the caliber causes brake pads 307 and 308 to exert a force on the rotating disc such that the rotation of axle 309 is reduced. Heat is generated by the friction of the pads pressing against the disc. Infrared camera 121B captures images of the brake components as these pass within the camera's field of view 322.

### Example Database of Records

Reference is now being made to FIG. 4 which illustrates a networked computing system and a database containing records of temperature thresholds for vehicle components based upon vehicle classification.

Networked workstation 403 includes a hard drive (internal to computer case 405) which reads/writes to computer readable media 406 such as a floppy disk, optical disk, CD-ROM, DVD, magnetic tape, etc. Case 405 also houses a motherboard with a processor and memory, a network card, graphics card, and the like, and other software and hardware. The workstation includes a user interface which comprises display 407 such as a CRT, LCD, touch screen, etc., mouse 408, and keyboard 409. It should be appreciated that the workstation has an operating system and other specialized software configured to display a variety of numeric values, text, scroll bars, pull-down menus with user selectable options, and the like, for entering, selecting, or modifying information displayed on display 407. Although shown as a desktop computer, it should be appreciated that computer 403 can be any of a laptop, mainframe, server, or a special purpose computer such as an ASIC, circuit board, dedicated processor, or the like. Information about the images including the classification of the vehicle and the identity of the isolated components may be entered by a user using the graphical user interface. Information may be communicated to a remote device over network 401 for storage or processing. Network 401 is shown as an amorphous cloud wherein packets of data are transmitted via special purpose devices placed in communication with each other via a plurality of communication links. Data is transferred between devices in the network in the form of signals which may be in any combination of electrical, electro-magnetic, optical, or other forms. Such signals are transmitted via wire, cable, fiber optic, phone line, cellular link, RF, satellite, or any other medium known in the arts.

Also shown are a plurality of records, collectively at 400, stored in database 404. A first record 402 is shown comprising a plurality of example data fields. There is a “MAKE” field containing the make of the vehicle, i.e., “FORD”, is stored. Similarly, there are “MODEL” and “YEAR” fields storing, respectively, the model of the vehicle, i.e., “MUSTANG”, and the vehicle's year, i.e., “1967”. A “COMPONENT” field stores information about the identity of the component, i.e., “FRONT DISC”, associated with this record. Also shown are a first, second, and third “THRESHOLD” fields each storing respective temperature thresholds. First record 402 further has a “RECOMMENDATIONS” field which, in this embodiment, stores recommendations as to what needs to be done if the component's estimated temperature is at or above one of the temperature thresholds. Example recommendations include “Replace”, “Service”, “Repair”, and the like. Some or all of the fields of any of the records in database 404 can be modified by a user, manipulated, sorted, and the like. Other fields may be added such as, for instance, an “ADDITIONAL COMMENTS” field wherein a user provides additional data desired to be associated with this component. In various embodiments, the field accepts alphanumeric characters of text entered via a standard keyboard. It should be appreciated that the information contained in the example collection of records 400 may be automatically generated and thus not requiring a user input. Record 402 is one example record for explanatory purposes.

Database 404 is capable of storing and retrieving records in response to a query. The database is also capable of adding new records, updating existing records, and providing retrieved records to a display device. Since database construction, query optimization, indexing methods, and record storage and retrieval techniques and algorithms are well known in the arts, a further discussion as to a specific database implementation is omitted. One of ordinary skill would be able to obtain a database from vendors in commerce and place that database in communication with a computer workstation in a manner as shown in FIG. 4.

### Flow Diagram of Example Embodiment

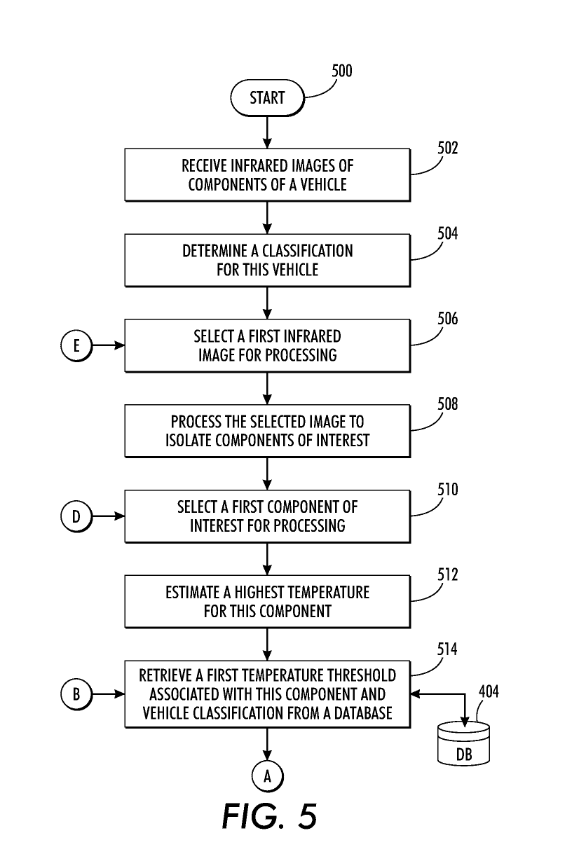

Reference is now being made to the flow diagram of FIG. 5 which illustrates one embodiment of the present method for determining vehicle system component failure due to overheating. Flow processing begins at step 500.

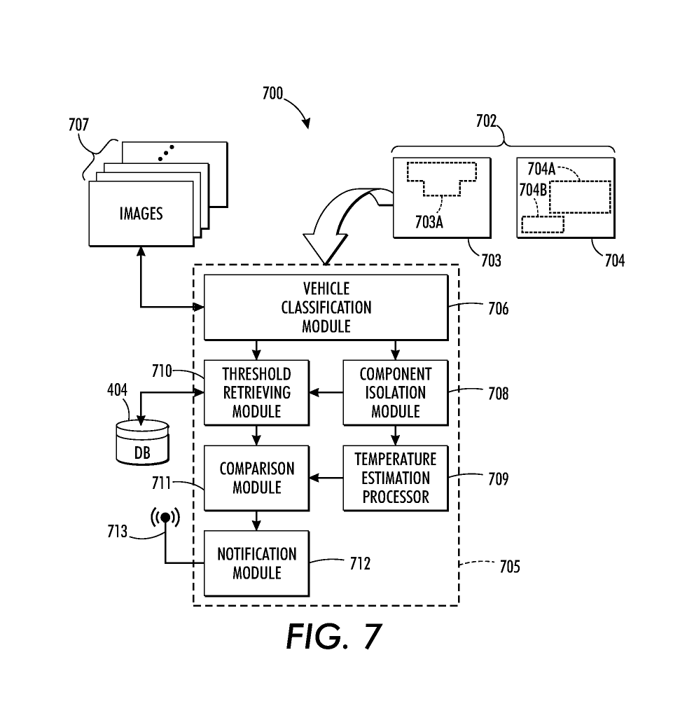

At step 502, a plurality of images of a vehicle are received. The images have been captured using an infrared camera such as any of the cameras in the array of cameras 120A-B of FIGS. 1-3. The images can be received from a remote device over a network using, for example, antenna 101 of FIG. 3. A plurality of images are shown and discussed with respect to images 702 of FIG. 7.

At step 504, a classification is determined for the vehicle. In various embodiments, determining the vehicle classification can be effectuated by capturing an image of the vehicle using, for instance, cameras 113A-D of FIG. 1, and then analyzing the images to determine the vehicle classification. In one embodiment, the vehicle classification is obtained by querying the vehicle's electronic tag to obtain the vehicle's make, model, and year. Assume for discussion purposes that vehicle 200 has been classified as a 1967 Ford Mustang as shown in the example record 402 of FIG. 4.

At step 506, a first infrared image is selected or otherwise identified for processing.

At step 508, the selected infrared image is processed to isolate components of interest. Isolated components are shown and discussed with respect to component 703A of image 703 and components 704A-B of image 704 of FIG. 7.

At step 510, a first component is selected or otherwise identified for processing. For discussion purposes, assume that this first selected isolated component is caliper 302 of FIG. 3. The captured images are preferably processed for components automatically but alternatively, a user can select all or a portion of an image for processing or otherwise identifies the component in the image by a visual inspection of the image displayed on a display device.

At step 512, a highest temperature is estimated for this component using the intensity values of the pixels of the image that are associated with the isolated component. For discussion purposes, assume that the isolated component has an estimated temperature of 161° F.

At step 514, a first temperature threshold for this component is retrieved from a database. The record associated with this component is retrieved from the database based upon the vehicle classification (step 504) and the selected component (step 508). For discussion purposes, a first temperature threshold of the record 402 of FIG. 4 associated with this selected component corresponds to “THRESHOLD1”, e.g., a temperature threshold of 198° F.

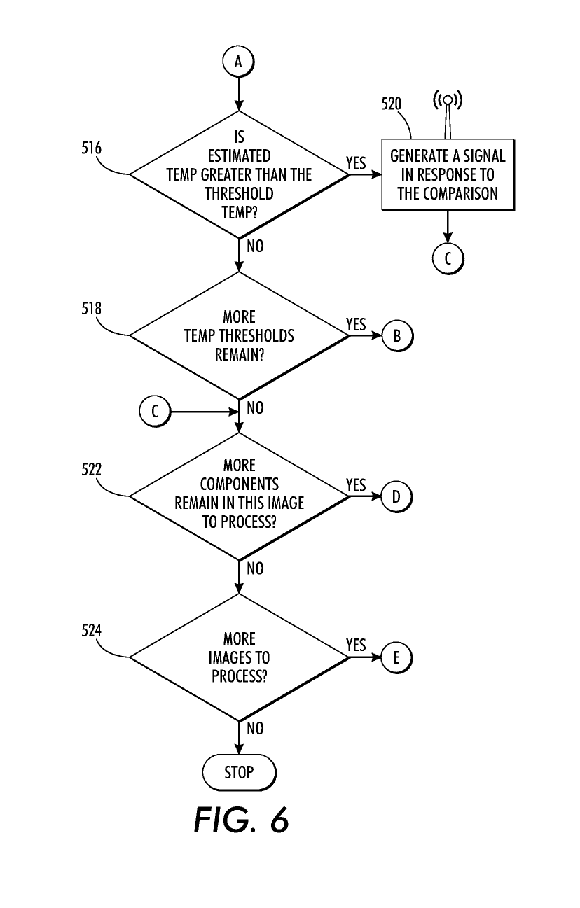

Reference is now being made to the flow diagram of FIG. 6 which is a continuation of the flow diagram of FIG. 5 with flow processing continuing with respect to node A.

At step 516, a determination is made whether this component's estimated highest temperature is greater than the temperature threshold retrieved (in step 514). The estimated temperature of 161° F. is not greater than the threshold of 198° F. As such, processing continues with respect to step 518 wherein a determination is made whether more temperature thresholds remain to be retrieved for this component. Record 402 is shown containing three temperature thresholds for this component. As such, processing repeats with respect to node B wherein, at step 514, a next second temperature threshold is retrieved from this record in the database. The second temperature threshold corresponds to “THRESHOLD2”, i.e., a threshold of 177° F. At step 516, this next retrieved threshold is compared to the component's estimated highest temperature. The component's estimated temperature of 161° F. is not greater than the second threshold temperature of 177° F. As such, processing continues with respect to step 518 wherein a determination is made whether any more temperature thresholds remain to be retrieved for this component. Record 402 contains a third temperature threshold so processing repeats with respect to node B wherein, at step 514, the third temperature threshold for this component is retrieved from the database. The third temperature threshold is “THRESHOLD3”, i.e., 152° F. The third temperature threshold is compared (at step 516) to the component's estimated highest temperature. The estimated temperature of 161° F. is greater than the third retrieved threshold temperature of 152° F. As such, processing continues with respect to step 520 wherein a signal is generated as a result of the comparison. The signal is sent to a vehicle inspection authority indicated that a certain temperature threshold has been reached for this component of this vehicle. Additional information may be communicated such as, for example, any of the recommendations in record 402. In this embodiment, processing continues with respect to node C wherein, at step 522, a determination is made whether any more components in this image remain to be processed. If so, processing continues with respect to node D wherein, at step 510 a next isolated component is selected. Processing repeats for this next component in a similar manner. If, at step 516, there are no more temperature thresholds to retrieve then processing continues with respect to step 522. Once all the components for this image have been processed, processing continues with respect to step 524 wherein a determination is made whether any more images remain to be processed. If so, then processing repeats with respect to node E wherein, at step 506, a next image is selected for processing. Processing repeats for all components of interest in this next selected image. Processing repeats until no more images remain to be selected. Thereafter, in this embodiment, further processing stops.

It should be appreciated that the flow diagrams hereof are illustrative. One or more of the operative steps illustrated in the flow diagram may be performed in a differing order. Other operations, for example, may be added, modified, enhanced, condensed, integrated, or consolidated. Such variations are intended to fall within the scope of the appended claims.

### Example System for Preserving User Markings

Reference is now being made to FIG. 7 which illustrates one example system for performing various aspects of the present method in accordance with the embodiment discussed with respect to the flow diagrams of FIGS. 5 and 6.

In the system 700 of FIG. 7, a plurality of infrared images, collectively at 702, are received from any of the camera arrays 120A-B. Shown in the first image 703 is an isolated component 703A (such as caliper 302 of FIG. 3 captured using camera 121B). Shown in image 704 are two isolated components 704A-B such as, for example, a section of an exhaust (at 704A) and a component of a transmission (at 704B) both of which have been captured using, for example, camera 123A. The images 702 are provided to image processor 705.

In this embodiment, Vehicle Classification Module 706 receives images 707 of vehicle 200 which have been captured by, for example, cameras 113C-D and proceeds to classify vehicle 200 by analyzing the received images. Alternatively, Module 706 receives the classification of vehicle 200 from RFID sensor 112B. In another embodiment, the user inputs the vehicle's classification using, for example, the user interface of workstation 403. Component Isolation Module 708 receives images 702 and isolates components such as components 703A and 704A-B for processing. Temperature Estimation Module 709 receives the isolated components from Module 708 either individually or collectively, and processed the images to estimate a highest temperature for each component based upon a camera calibration curve that relates temperature to the pixel intensity values associated with those components. Threshold Retrieving Module 710 receives the vehicle classification from Module 706, and the component from Module 708 and queries database 404 to retrieve one or more records containing the temperature threshold(s) associated with this component and vehicle classification. The retrieved temperature thresholds are provided to Comparison Module 711 which determines whether the temperature estimated for the isolated component exceeds the retrieved threshold value. Notification Module 712 receives a result of the comparison from Module 711 and proceeds to notify an inspection authority using, for example, Wireless Transmission Element 713. Notification Module 712 may also provide notification to the vehicle's registered owner such as, for instance, the test results including any of the recommendations associated with this component and threshold combination. Such a notification can take the form of a text message sent to a cellphone of the registered owner, or a pre-recorded voice, text, or video message sent to the owner's email address or voice messaging inbox. A message may be sent to the vehicle's ON-STAR system (where equipped) which audibly recites a message to the vehicle's driver and passengers. The vehicle's RFID tag may be updated with the test comparison results along with any other information. The cost of the inspection may be automatically deducted from a pre-funded account associated with the vehicle's electronic tag.

It should be understood that any of the modules and processors of FIG. 7 are in communication with workstation 403 of FIG. 4 via pathways not shown and may further be in communication with one or more remote devices over network 401 to store/retrieve data, parameter values, functions, records, data, and machine readable/executable program instructions required to perform their intended functions. Any of the Information obtained from any of the modules of system 700 can be saved to database 404. Some or all of the functionality of any of the modules of the block diagram of FIG. 7 may be performed, in whole or in part, by components internal to workstation of FIG. 4 or by a special purpose computer system.

Various modules may designate one or more components which may, in turn, comprise software and/or hardware designed to perform an intended function. A plurality of modules may collectively perform a single function. Each module may have a specialized processor and memory capable of executing machine readable program instructions. A module may comprise a single piece of hardware such as an ASIC, electronic circuit, or special purpose processor. A plurality of modules may be executed by either a single special purpose computer system or a plurality of special purpose systems operating in parallel. Connections between modules include both physical and logical connections. Modules may further include one or more software/hardware components which may further comprise an operating system, drivers, device controllers, and other apparatuses some or all of which may be connected via a network. It is contemplated that one or more aspects of the present method may be implemented on a dedicated system or practiced in a distributed computing environment where tasks are performed by devices that are linked together over a network.

The teachings hereof can be implemented in hardware or software using any known or later developed systems, structures, devices, and/or software by those skilled in the applicable art without undue experimentation from the functional description provided herein with a general knowledge of the relevant arts. Such a special purpose computer system is capable of executing machine executable program instructions and may comprise a micro-processor, micro-controller, ASIC, electronic circuit, or any combination thereof.

One or more aspects of the methods described herein are intended to be incorporated in an article of manufacture, including one or more computer program products, having computer usable or machine readable media. The article of manufacture may be included on at least one storage device readable by a machine architecture embodying executable program instructions capable of performing the methodology and functionality described herein. Additionally, the article of manufacture may be included as part of a complete system or provided separately, either alone or as various components.

It will be appreciated that various of the above-disclosed and other features and functions, or alternatives thereof, may be desirably combined into many other different systems or applications. Presently unforeseen or unanticipated alternatives, modifications, variations, or improvements therein may become apparent and/or subsequently made by those skilled in the art, which are also intended to be encompassed by the following claims. Accordingly, the embodiments set forth above are considered to be illustrative and not limiting. Various changes to the above-described embodiments may be made without departing from the spirit and scope of the invention. The teachings of any printed publications including patents and patent applications, are each separately hereby incorporated by reference in their entirety.

What is claimed is:

1. A method for video-based determination of whether a vehicle's component is at risk of failure due to overheating, the method comprising:
receiving at least one infrared image of at least one component of a vehicle captured using an infrared camera, said infrared image comprising an array of pixels with each pixel having intensity values measured at desired wavelength bands of interest;
determining a classification of said vehicle;
processing said images to isolate a location of at least one component of interest intended to be analyzed for temperature;
for each of said isolated components:
estimating a highest temperature for said component using a camera calibration curve which relates pixel intensity values to temperature;
retrieving, based upon said vehicle classification, at least one temperature threshold predetermined for said component; and
comparing said estimated highest temperature to said retrieved temperature threshold; and
initiating a signal in response to said estimated temperature for any of said components being above said component's respective temperature threshold.

2. The method of claim 1, wherein said infrared camera comprises any of: a Long Wave Infrared (LWIR) camera, and a Mid Wave Infrared (MWIR) camera.

3. The method of claim 1, wherein said vehicle component comprises any of: a brake system, an exhaust system, an engine, a transmission, a radiator and a wheel bearing.

4. The method of claim 1, wherein said infrared camera is mounted on any of: on a road positioned beneath the vehicle, and on a side of said road with mirrors mounted on said road beneath said vehicle such that said camera captures images of a reflection of said components.

5. The method of claim 1, wherein determining said vehicle classification comprises any of: capturing an image of said vehicle and analyzing said image to determine said vehicle classification, querying a RFID tag affixed to said vehicle, and inputting any of: said vehicle's make, model, year, and vehicle identification number.

6. The method of claim 1, wherein said vehicle classification comprises any of: a passenger car, a passenger van, a cargo van, a light duty truck, a heavy duty truck, a bus, farm equipment, off-road vehicles, a race car, a motorcycle, a tractor trailer, electric vehicles, a train, and a plane.

7. The method of claim 6, wherein said vehicle classification further comprises any of: said vehicle's make, model, year, and vehicle component type.

8. The method of claim 1, wherein said vehicle components are isolated in said images using any of: a Hough transform on a binarized gradient field of said image, a training-based object classification method, and a template matching and correlation method.

9. The method of claim 1, wherein said temperature thresholds are obtained by any of: tests conducted of component temperature failures in a temperature-controlled environment, a Department of Transportation (DoT) agency, an Underwriters Laboratory (UL), and a manufacturer's specification.

10. The method of claim 1, further comprising communication a result of said comparison to a vehicle inspection authority.

11. A system for determination of whether a vehicle's component is at risk of failure due to overheating, the system comprising:
an infrared (IR) camera system;
a database containing temperature thresholds for different vehicle components;
a processor in communication with said video camera system and a memory, said processor executing machine readable instructions for performing:
receiving at least one infrared image of at least one component of a vehicle captured using said infrared camera, said infrared image comprising an array of pixels with each pixel having intensity values measured at desired wavelength bands of interest;
determining a classification of said vehicle;
processing said images to isolate a location of at least one component of interest intended to be analyzed for temperature;
for each of said isolated components:
estimating a highest temperature for said component using a camera calibration curve which relates pixel intensity values to temperature;
retrieving, based upon said vehicle classification, at least one temperature threshold predetermined for said component; and
comparing said estimated highest temperature to said retrieved temperature threshold; and
initiating a signal in response to said estimated temperature for any of said components being above said component's respective temperature threshold.

12. The system of claim 11, wherein said infrared camera comprises any of: a Long Wave Infrared (LWIR) camera, and a Mid Wave Infrared (MWIR) camera.

13. The system of claim 11, wherein said vehicle component comprises any of: a brake system, an exhaust system, an engine, a transmission, a radiator and a wheel bearing.

14. The system of claim 11, wherein said infrared camera is mounted on any of: on a road positioned beneath the vehicle, and on a side of said road with mirrors mounted on said road beneath said vehicle such that said camera captures images of a reflection of said components.

15. The system of claim 11, wherein determining said vehicle classification comprises any of: capturing an image of said vehicle and analyzing said image to determine said vehicle classification, querying an electronic tag affixed to said vehicle, and inputting any of: said vehicle's make, model, year, and vehicle identification number.

16. The system of claim 11, wherein said vehicle classification comprises any of: a passenger car, a passenger van, a cargo van, a light duty truck, a heavy duty truck, a bus, farm equipment, off-road vehicles, a race car, a motorcycle, a tractor trailer, electric vehicles, a train, and a plane.

17. The system of claim 16, wherein said vehicle classification further comprises any of: said vehicle's make, model, year, and vehicle component type.

18. The system of claim 11, wherein said vehicle components are isolated in said images using any of: a Hough transform on a binarized gradient field of said image, a training-based object classification method, and a template matching and correlation method.

19. The system of claim 11, wherein said temperature thresholds are obtained by any of: tests conducted of component temperature failures in a temperature-controlled environment, a Department of Transportation (DoT) agency, an Underwriters Laboratory (UL), and a manufacturer's specification.

20. The system of claim 11, further comprising communication a result of said comparison to a vehicle inspection authority.

21. A computer implemented method for video-based determination of whether a vehicle's component is at risk of failure due to overheating, the method comprising:
receiving at least one infrared image of at least one component of a vehicle captured using an infrared camera comprising any of: a Long Wave Infrared (LWIR) camera, and a Mid Wave Infrared (MWIR) camera, said infrared image comprising an array of pixels with each pixel having intensity values measured at desired wavelength bands of interest;
determining a classification of said vehicle;
processing said images to isolate a location of at least one component of interest intended to be analyzed for temperature;
for each of said isolated components:
estimating a highest temperature for said component using a camera calibration curve which relates pixel intensity values to temperature;
retrieving, based upon said vehicle classification, at least one temperature threshold predetermined for said component; and
comparing said estimated highest temperature to said retrieved temperature threshold; and
initiating a signal in response to said estimated temperature for any of said components being above said component's respective temperature threshold.

22. The computer implemented method of claim 21, wherein said vehicle component comprises any of: a brake system, an exhaust system, an engine, a transmission, a radiator and a wheel bearing.

23. The computer implemented method of claim 21, wherein determining said vehicle classification comprises any of: capturing an image of said vehicle and analyzing said image to determine said vehicle classification, querying an electronic tag affixed to said vehicle, and inputting any of: said vehicle's make, model, year, and vehicle identification number.

24. The computer implemented method of claim 21, wherein said vehicle classification comprises any of: a passenger car, a passenger van, a cargo van, a light duty truck, a heavy duty truck, a bus, farm equipment, off-road vehicles, a race car, a motorcycle, a tractor trailer, electric vehicles, a train, and a plane.

25. The computer implemented method of claim 21, further comprising communication a result of said comparison to a vehicle inspection authority.
